(19) United States
(12) Patent Application Publication
(10) Pub. No.: US 2009/0102299 A1
(43) Pub. Date: Apr. 23, 2009

(54) Transmission/Drive Unit With A Symmetrically Positioned Connecting Plug

(75) Inventors: Rico Lampert, Plymouth, MI (US); Walter Haussecker, Buehlertal (DE); Thomas Huck, Rheinmuenster (DE); Tarek Mili, Karlsruhe (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 11/917,868

(22) PCT Filed: May 3, 2006
(86) PCT No.: PCT/EP2006/062033

§ 371 Date: May 19, 2008

(30) Foreign Application Priority Data
Jun. 22, 2005 (DE) 102005028815.4

(51) Int. Cl. H02K 7/116; H02K 11/00

(52) U.S. Cl. 310/71; 310/83

(57) ABSTRACT

Transmission/drive unit (10) having a housing (16, 18, 20) which contains an electric motor (12), which has an armature core (24) and an armature shaft (22) having a worm (26), and a transmission (14) which is arranged downstream of said armature shaft, with the transmission (14) having an output gear (34) which is mounted on a rotary shaft (36), with an electrical connecting plug (58) being arranged on the housing (16, 18, 20) between the armature core (24) and the worm (26), and the housing (16, 18, 20) being formed approximately symmetrically to a plane of symmetry (46) which is arranged transverse to the armature shaft (22) and runs through the connecting plug (58) and through the rotary shaft (36) of the output gear (34).

### RELATED ART

The present invention relates to a transmission drive unit with an electric motor and a transmission, according to the preamble of independent claim 1.

Publication DE 103 34 611 A1 made known a transmission drive unit of this type, with which an electric motor with a downstream, multiple-speed transmission is located in a shell-type housing. In a special embodiment, this housing is designed approximately symmetrical with the bearing shaft of an output element and with the center of mass of the drive unit. An electrical connecting plug is not disclosed with this embodiment. The commutator is located at one end of the armature shaft, so the connecting plug is located approximately at one end of the armature shaft, as is the case with further similar exemplary embodiments of the patent mentioned above.

The disadvantage of an embodiment of this type is that, when a single identical drive type is used for various installation positions—as is necessary, e.g., for power window drives installed in the left and right-hand doors of the vehicle—, the electrical cable must be routed differently. Two different variants of the embodiment must therefore be taken into consideration when designing and installing the wiring harness, which results in a great deal of additional work.

### ADVANTAGES OF THE INVENTION

The inventive transmission drive unit having the features of independent claim 1 has the advantage that, via the symmetrical positioning of the electrical connecting plug relative to a plane of symmetry that is perpendicular to the armature shaft, the drive unit may be connected with the electrical leads in an identical manner in different installation positions. To accomplish this, the electrical connecting plug is located—on the housing—not at the end of the armature shaft, but rather nearly in the center of the armature shaft. The plane of symmetry extends approximately through the center of the driven wheel and through the connector pin of the connecting plug.

Advantageous refinements of the device according to the independent claims are made possible by the measures listed in the subclaims. The pins of the connecting plug are preferably positioned in the radial direction relative to the armature shaft, so that the corresponding counterplug may be connected with the connecting plug in a nearly identical manner in both installation positions, approximately in the center of the armature shaft.

To this end, a commutator and a position sensor—which interact with a compact electromechanical module—are located approximately in the center of the armature shaft. This module transmits the electrical drive current and the position signals from and to the armature shaft and is simultaneously electrically connected with the connecting plug, thereby resulting in very short electrical paths inside the housing.

In a preferred embodiment, the shell-type housing includes a nearly triangular base surface, with the armature shaft extending along the base side of this triangle, and the plane of symmetry defining the height of a nearly isoceles triangle. As a result the housing has a very compact, minimally fissured, symmetrical outer contour, whch may be installed in an identical manner in various installation positions.

To install the drive unit in the left and right-hand door of the vehicle in the same manner, the screw-on points of the drive unit are also positioned symmetrically to the plane of symmetry. To this end, screw-on towers are integrally formed, e.g., on the outer circumference of the housing, or they are integrated in the housing, with, e.g., three screw-on points being located on the plane of symmetry.

To ensure that the rotation axis of the driven wheel may be located on the plane of symmetry and, therefore, nearly in the center of the housing, an intermediate gear is located between the worm and the drive wheel to transfer torque. The dimensions of the gearwheels is advantageously selected such that the symmetry conditions are fulfilled and the desired reduction is attained.

It is advantageous when the intermediate gear is connected with a further transmission gearwheel on the same axis, the intermediate wheel meshing with the worm, and the further transmission gearwheel meshing with the driven wheel.

To redirect the transmission forces that occur to the housing, it is particularly favorable to mount the driven wheel on a first, non-rotatable shaft, and to locate the intermediate gearwheel—with the further transmission gearwheel—on a second shaft. The two rotation axes may be designed as bearing bolts fixed in the housing, in a manner that is easily fabricated.

Given that the further transmission gearwheel is located axially next to the intermediate gearwheel and, therefore, it is displaced relative to the longitudinal axis of the armature shaft, the driven wheel is located along the rotation axis such that it is also displaced relative to the armature shaft. The overall height of the transmission housing may therefore be reduced in the region of the driven wheel, which is advantageous for many displacement applications in the motor vehicle.

When, e.g., the driven wheel and the further transmission gearwheel have minimal separation from the base surface of the housing, or if they bear axially against the flat base surface, the base surface of the housing may be easily designed as a flat surface, by way of which installation space for torque transmission means may be provided axially above the driven gearwheel in the region of the low housing height.

Particularly advantageously, a cable drum or a driven pinion—which is non-rotatably connected with the driven wheel—may be located on the first rotation axis. The moment transmission element may be designed in a customer-specific manner, and it may be part of a more complex mechanical system, which, e.g., displaces a movable part in the motor vehicle. The advantage of this is that additional installation space is not required in the axial direction along the first rotation axis in order to transfer force. A drive unit of this type, which is very flat in design compared with the overall height of the drive unit in the region of the driven wheel, is of particular interest for many applications in the motor vehicle, such as in a sliding sunroof, in side doors, or for seat adjustment.

### DRAWING

Various exemplary embodiments of an inventive transmission drive unit are presented in the drawing, and they are described in greater detail in the description below.

FIG. 1 shows a first exemplary embodiment of a transmission drive unit, and

FIG. 2 shows a view of further exemplary embodiments, and

FIG. 3 shows a cross section along line III-III of the drive unit in FIG. 2.

### DESCRIPTION OF THE EXEMPLARY EMBODIMENTS

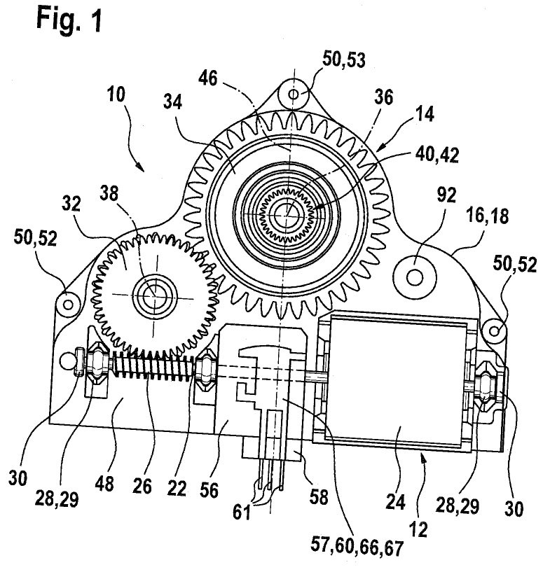

Using a power window drive 10 as an example, FIG. 1 shows a transmission drive unit 10, with which an electric motor 12 and a transmission 14 are located in the same housing 16. A first shell-type housing part 18 is shown in FIG. 1, which may be closed with a second housing part 20, which is designed as a cover and is not described in detail. Complete electric motor 12 with an armature stack 24 and an armature shaft 22 with a worm 26 mounted thereon are located in shell-type housing part 18. Armature shaft 22 is supported in housing 16 via several bearings 28, which are designed, e.g., as calotte bearings 29. Thrust washers 30 are located on the ends of armature shaft 22 to serve as axial stops. In the exemplary embodiment, worm 26 meshes with an intermediate gearwheel 32, which is also engaged with a driven wheel 34. Driven wheel 34 is rotatably supported on a first rotation axis 36, and intermediate wheel 32 is rotatably supported on a second rotation axis 38. A driven pinion 40 is non-rotatably connected with driven wheel 34. Driven pinion 40 serves as torque transmission element 42 of a mechanical system 44, which is not described in detail, and which is used, e.g., to adjust a movable part in the motor vehicle. Housing 16 is designed symmetrical to a plane of symmetry 46, which extends approximately perpendicularly to armature shaft 22 and through first rotation axis 36 of driven wheel 34. In the exemplary embodiment, first housing part 18 has an approximately triangular base surface 48, which is subdivided via plane of symmetry 46 into two identical triangular surfaces. Fastening points 50 are located on housing 16, which are also located symmetrically to plane of symmetry 46. Three fastening towers 52, for example, are integrally formed on housing 16. A first fastening tower 53 is located directly in the plane of symmetry, and two further fastening towers 52 are integrally formed in the region of the ends of armature shaft 22 such that they are symmetrical to plane of symmetry 46. Housing 16 is formed, e.g., as a plastic injection-moulded part, so that fastening towers 52 may be manufactured as a single piece therewith. An electronics module 56 is located in housing 16 in the region where plane of symmetry 46 intersects armature shaft 22. Electronics module 56 is electrically connected with a connecting plug 58, which is integrally formed on housing 16 in the region of plane of symmetry 46. Connecting plug 58 includes several pins 61, which transmit motor current and position signals. To this end, electronics module 56 includes a brush holder 60, which interacts with a commutator 62 located on armature shaft 22. A position sensor 64, e.g., in the form of an annular magnet 65, is also located on armature shaft 22, the position signals of which are registered by a signal receiver 66, which is designed, e.g., as a Hall sensor system 67. In the exemplary embodiment, electronics module 56 has a sandwich design, with which several electrically conductive substrates are coated with a casting compound, which is applied via injection moulding, thereby forming a compact plastic body 56. Electronics module 56 includes a pressed screen 57, which is connected with individual pins 61 of connecting plug 58. Electronics module 56 is intersected by plane of symmetry 45, but it is not symmetrical therewith. Connecting plug 58 with pins 61 is designed approximately symmetrical to plane of symmetry 46, however, so that the corresponding, not-shown counterplug of the supply lines may be located in various installation positions in an identical manner.

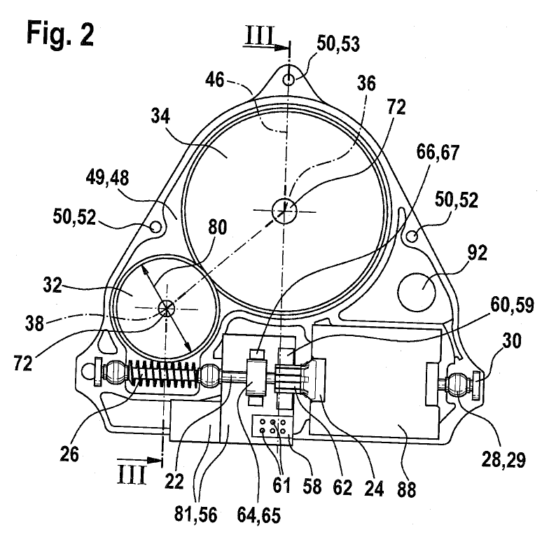

A further exemplary embodiment of a transmission drive unit 10 without cover 20 is shown in FIG. 2. The drive moment is transmitted via worm 26 to intermediate gearwheel 32. A further transmission gearwheel 70, which meshes with driven wheel 34, is non-rotatably connected with intermediate gear 32. Base surface 48 of shell-type housing part 18 is designed as a flat surface 49, on which the two rotation axes 36 and 38 are formed as bearing bolts 72 fixed to the housing.

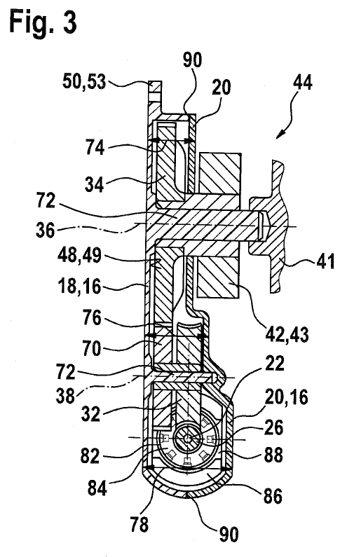

As shown in FIG. 3, transmission gearwheel 70 is located between base surface 48 and armature shaft 23 with the least amount of clearance from base surface 48. As a result, driven wheel 34 is also located directly on flat base surface 48 on first rotation axis 38, so that housing 16 has a much lower overall height 74 in this region than overall height 76 in the region of intermediate gearwheel 32 or overall height 78 in the region of the armature stack. Cover 20 of housing 16 therefore has a stepped design, so that moment transmission element 42 is non-rotatably connectable with driven wheel 34 in the region of driven wheel 34 outside of housing 16 on first rotation axis 36. Due to minimum overall height 74 in the region of driven wheel 34, a very flat transmission drive unit 10 may also be created after customer-specific moment transmission element 42 is installed. Transmission drive unit 10 may also be integrated in an identical manner in various installation positions in adjustment mechanics 44 of the part to be adjusted.

In FIG. 3, torque transmission element 42 is designed as cable drum 43. Bearing bolt 72 of first rotation axis 36 is counter-supported in a housing part 41 of moment transmission element 42. Intermediate gearwheel 32 and further transmission gearwheel 70—which are supported together on bearing bolt 72, which is integrally formed on base surface 48—have nearly the same diameter 80 in FIG. 3. In a variation, diameters 80 of intermediate gearwheel 32 and transmission gearwheel 70 may also deviate from each other, in order to realize another gear reduction.

As shown in FIG. 2, housing 16 is designed symmetrical to plane of symmetry 46, which extends through rotation axis 36 of driven wheel 34 and intersects armature shaft 22 nearly in the center. In this case, screw-on points 50 are more strongly integrated in the housing contour, and they are also positioned symmetrical to plane of symmetry 46. In this exemplary embodiment, connecting plug 58 with pins 61 are not located exactly with plane of symmetry 46, but the deviation from the exact symmetry is so slight that it is negligible for the location of the corresponding counterplug at the corresponding installation positions of drive 10. In this case, pins 61 extend radially relative to armature shaft 22, although, in this case, they are approximately perpendicular to base surface 48 and/or cover 20 of housing 16. Pins 61 are connected with electronics module 56, which is designed as printed circuit board 81 in this embodiment. Hall sensors 67—as signal receivers 66—are located on printed circuit board 81. Hall sensors 67 interact with an annular magnet 65 as position sensor 64 on armature shaft 22. Brush holders 60, which are designed, e.g., as hammer brushes 59, and which establish the power supply with commutator 62, are also mounted on electronics module 56. Commutator 62 is electrically connected with windings 84, which are located on laminations 82 and form armature stack 24. Armature stack 24 is driven via permanent magnets 86, which are interconnected via a magnetic flux return 88, and which are located inside shell-type plastic housing 16. A seal 90 is located between the two housing parts 18 and 20, approximately in a plane and without gradations, as shown in FIG. 3. As shown schematically in FIG. 2, a diaphragm 92 is located in housing cover 20, which enable pressure to be compensated for between the housing interior and the surroundings without allowing moisture to penetrate diaphragm 92.

It should be noted that, with regard for the exemplary embodiments presented in the figures and the description, many different combinations of the individual features are possible. For example, the specific design of the housing contour may deviate from a triangular base surface, and may be, e.g., oval or quadrangular in design, while housing 16 is always designed approximately symmetrical to plane of symmetry 46. Likewise, the location and design of connecting plug 58 and pins 61 may be varied, and they should be located on plane of symmetry 46 at least approximately such that the corresponding counterplug may always be located at the same point in various installation positions of drive 10. Connecting plug 58 with pins 61 may extend along base surface 48 or nearly perpendicularly thereto. Connecting plug 58 may therefore also be positioned at angles in the region of plane of symmetry 46. The specific embodiment of transmission 14 may also be varied, e.g., it may include several gear stages with further rotation axes, with rotation axis 36 of driven wheel 34 being located in plane of symmetry 46 of housing 16. In particular, the inventive reduction of overall height 74 in the region of driven wheel 34 may also be realized independently of the location of connecting plug 58 relative to plane of symmetry 46. The present invention is preferably used to drive window panes in a motor vehicle, it being possible to install identical transmission drive unit 10 in either the left or right-hand vehicle door.

What is claimed is:

1. A transmission/drive unit (10) with a housing (16, 18, 20), which contains an electric motor (12) with an armature stack (24) and an armature shaft (22) with a worm (26), and a transmission (14), which is located downstream of armature shaft (22), the transmission (14) including a driven wheel (34), which is mounted on a rotary axis (36),
wherein
an electrical connecting plug (58) is located on the housing (16,18, 20) between the armature stack (24) and the worm (26), and the housing (16, 18, 20) is designed approximately symmetrically to a plane of symmetry (46) that is located transversely to the armature shaft (22) and extends through the connecting plug (58) and the rotary axis (36) of the driven wheel (34).

2. The transmission drive unit (10) as recited in claim 1,
wherein
the connecting plug (5) includes connector pins (61), which extend radially away from the armature shaft (22).

3. The transmission drive unit (10) as recited in claim 1,
wherein
the connector pins (61) are connected with a compact electronics module (56), which is intersected by the plane of symmetry (46) and interacts with a commutator (62) and a position sensor (64) that are located on the armature shaft (22).

4. The transmission drive unit (10) as recited in claim 1,
wherein
the housing (16, 18, 20) essentially includes a triangular base surface (24), which is subdivided by the plane of symmetry (46) into two approximately identical triangles.

5. The transmission drive unit (10) as recited in claim 1,
wherein
the housing (16, 18, 20) includes a screw-on pattern for fastening to the motor vehicle that is also designed essentially symmetrical to the plane of symmetry (46), with at least one screw-on point in particular being located in the plane of symmetry (46).

6. The transmission drive unit (10) as recited in claim 1,
wherein,
to transfer torque between the worm (26) and the driven element (34), an intermediate gear (32) is located on a second rotation axis (38), which meshes with the worm (26) in particular.

7. The transmission drive unit (10) as recited in claim 1,
wherein
a further transmission gearwheel (70) is located on the second rotation axis (38), which is non-rotatably connected with the intermediate gear (32) and engages with the driven wheel (34) in particular.

8. The transmission drive unit (10) as recited in claim 1,
wherein
the first and/or second rotation axis (36, 38) are/is designed as a bearing bolt (72) fixed in the housing, on which the driven wheel (34) and the intermediate gear (32) are rotatably supported.

9. The transmission drive unit (10) as recited in claim 1,
wherein
the housing (16) includes an essentially shell-type main body (18) and a cover (20) that may be installed radially to the armature shaft (22); when the housing (16, 18, 20) is closed, an overall height (74, 76, 78) of the housing (16, 18, 20) results, the overall height (74) in the region of the driven element (34) being less than the overall height (76) in the region of the intermediate gear (32).

10. The transmission drive unit (10) as recited in claim 1,
wherein
the base surface (48) of the housing (16, 18, 20) is designed approximately as a flat base surface (49), and the driven wheel (34) and the transmission gearwheel (70) are located directly adjacent to the base surface (49).

11. The transmission drive unit (10) as recited in claim 1,
wherein
a moment transmission element (42), e.g., a cable drum (43) or a driven pinion (40), is located in the region of the lower overall height (74) outside of the housing (16, 18, 20), which is non-rotatably connected with the driven wheel (34), and, in particular, displaces a movable part in the motor vehicle.
